(19) United States
(12) Patent Application Publication
(10) Pub. No.: US 2023/0138305 A1
(43) Pub. Date: May 4, 2023

(54) MITIGATION OF UNINTENDED LATERAL MOTION OF VEHICLE POWERTRAIN SYSTEM HAVING MULTIPLE PROPULSION ACTUATORS

(71) Applicant: GM GLOBAL TECHNOLOGY OPERATIONS LLC, Detroit, MI (US)

(72) Inventors: Richard A. Kulas, Dexter, MI (US); Douglas J. Moening, Highland, MI (US); Abdoulaye T. Diallo, Wixom, MI (US); Jenna C. Pechauer, Fenton, MI (US); Aubrey W. Downs, JR., Brighton, MI (US)

(73) Assignee: GM GLOBAL TECHNOLOGY OPERATIONS LLC, Detroit, MI (US)

(21) Appl. No.: 17/515,947

(22) Filed: Nov. 1, 2021

(51) Int. Cl. B60W 30/02; B60W 50/00

(52) U.S. Cl. CPC B60W 30/02; B60W 50/0098; B60W 2520/26; B60W 2520/14; B60W 2520/125; B60W 2540/18; B60W 2710/0644

(57) ABSTRACT

A method mitigates an unintended lateral motion (ULM) event of a motor vehicle having a powertrain system with multiple propulsion actuators. The method, which may be recorded on a computer readable storage medium and executed therefrom by a processor, includes identifying, via an electronic controller of the motor vehicle, a present dynamic operating region at an onset of the ULM event as a linear or non-linear operating region. Lateral motion includes lateral acceleration and/or lateral yaw of the motor vehicle. The method also includes determining whether the lateral motion exceeds calibrated lateral dynamic limits for the particular operating region, and executing a powertrain control action in different manners depending on whether the ULM event occurs in the non-linear or linear operating region. The powertrain control action includes changing a dynamic speed state of at least one of the propulsion actuators.

### INTRODUCTION

Motor vehicles and other mobile platforms are equipped with a powertrain system having one or more propulsion actuators. Automobiles in particular are typically powered by an internal combustion engine, with combustion-generated engine output torque ultimately delivered to one or more road wheels of the motor vehicle via a planetary transmission or gearbox. In contrast, hybrid electric vehicles selectively utilize motor output torque supplied by one or more electric traction motors, with the motor output torque supplied alone or in combination with the engine output torque depending on the current powertrain operating mode. Battery electric vehicles, which are also referred to in the art as full electric vehicles, utilize one or more traction motors as propulsion actuators, but forgo use of the engine and its associated mass and onboard fuel supply. Vehicle powertrain systems employing one or more traction motors for vehicular propulsion, regardless of the presence or absence of other propulsion actuators, are considered herein and in the general art to be “electrified”.

During operation of a motor vehicle, tires mounted on the motor vehicle's various road wheels are expected to remain in direct rolling contact with an opposing road surface under typical driving conditions. To this end, powertrain control systems may rely on a vehicle dynamics model and a range of sensor inputs to identify regions of operation in which the motor vehicle is permitted to operate. Such vehicle dynamics models account for the specific mass, size, weight distribution, and configuration of the various propulsion actuators to determine, in real-time, how a given set of control inputs and state values will likely affect the vehicle's output state.

Part of this ongoing analysis may include reference to a tire model, which in turn is used to translate interactions between the tires and the road surface into corresponding values such as axle forces and moments, tire slip ratios, and tire slip angles. Vehicle dynamics models are thus used to determine whether a motor vehicle is presently operating in a linear operating region, in which case the vehicle is operating under expected steady-state conditions indicative of optimal vehicle stability and control, or whether the motor vehicle has instead transitioned into a less well-defined non-linear operating region.

### SUMMARY

The present disclosure pertains to dynamic control of a motor vehicle during an unintended lateral motion (ULM) event. In particular, the methods and associated hardware-based systems described below pertain to real-time control of an electrified powertrain system having multiple sources of propulsion torque, hereinafter referred to as propulsion actuators. In different representative embodiments the propulsion actuators include an internal combustion engine and one or more electric traction motors in a hybrid electric configuration of the electrified powertrain system, or multiple traction motors in a representative full electric configuration.

Within the scope of the disclosure, the ULM event is “unintended” in the sense that the lateral motion, whether as lateral acceleration, lateral yaw rate, or both, may be erroneously commanded by an onboard powertrain control module or other resident controller. The principal factor or root cause of the ULM event addressed herein is that of a malfunctioning propulsion actuator, and thus the resident controller is programmed in software and equipped in hardware (“configured”) to address the possibility of a malfunctioning propulsion actuator via mitigating powertrain control actions as described in detail below.

To that end, a method is disclosed herein for automatically mitigating a ULM event of a motor vehicle having a powertrain system with multiple propulsion actuators, e.g., an engine and one or more electric traction motors, with each propulsion actuator being configured to provide a corresponding output torque for the purpose of propelling the motor vehicle via a set of road wheels. The method according to an exemplary embodiment includes identifying, via an electronic controller of the motor vehicle, a present dynamic operating region of the motor vehicle. This action occurs at an onset of the ULM event. The present dynamic operating region within the scope of the present disclosure is either linear or non-linear, i.e., within the context of stability limits determined with reference to a calibrated vehicle dynamics model (VDM), as is well understood in the art. Lateral motion of the motor vehicle occurring during the ULM event may include a lateral acceleration and/or a lateral yaw rate of the motor vehicle as noted above.

The method in this particular embodiment includes determining, via the electronic controller, whether the lateral motion exceeds calibrated lateral dynamic limits for the identified present dynamic operating region. As part of the method, the electronic controller executes a powertrain control action suitable for mitigating the ULM event, with the electronic controller performing the control action in a first manner when the ULM event occurs while the motor vehicle operates in the non-linear operating region, and in a different second manner when the ULM event occurs during the linear operating region. The powertrain control action contemplated herein includes changing a dynamic output state of at least one of the propulsion actuators, for instance reducing an output torque and/or speed thereof, with “reducing” encompassing, at the extreme, the possibility of shutting off or powering down the propulsion actuator(s) as the situation warrants.

The first manner of intervention contemplated herein substantially or fully disables a propulsion capability of the motor vehicle, with “substantially” in this context allowing for a limited torque capability, e.g., 10-20% or less of a total torque capability of the collective set of propulsion actuators, which may be sufficient for executing a “limp home” mode enabling the operator to reach a suitable parking destination or a maintenance facility. The second manner is progressive in nature, allowing the controller to first attempt to restore the motor vehicle to operation within the lateral dynamic limits before disabling the propulsion capability of the motor vehicle.

The method disclosed herein may include detecting the onset of the ULM event by measuring the lateral acceleration and/or the lateral yaw rate of the motor vehicle. Determining whether the lateral motion exceeds the calibrated lateral dynamic limits may include comparing the lateral motion to one or more lookup tables stored in memory of the electronic controller.

Comparing the lateral motion of the motor vehicle to the lookup table(s) may include comparing a lateral tire force and a tire slip angle of the road wheels of the motor vehicle to calibrated stability thresholds, with such stability thresholds possibly being stored in one or more lookup tables, i.e., on a tangible computer-readable storage medium.

The motor vehicle in some embodiments includes a steering wheel and a steering angle sensor configured to measure a steering angle thereof. The steering angle sensor outputs an electronic signal, e.g., a voltage signal, which in turn is indicative of the measured steering angle. The method in this instance may include measuring the steering angle via the steering angle sensor, and thereafter transmitting the steering angle signal to the controller. Determining the dynamic operating region may include processing the steering angle signal via the electronic controller.

In some aspects of the disclosure, the powertrain control action includes fully disabling a propulsion capability of the motor vehicle via the electronic controller when the ULM event occurs during the linear operating region. For instance, the various propulsion actuators may be commanded to turn off over a predetermined shutdown duration, thereby temporarily rendering the motor vehicle immobile. Executing the powertrain control action may also include executing a first control action when the ULM event occurs during the non-linear operating region, with the first control action possibly including reducing a respective propulsion capability of at least one but fewer than all of the multiple propulsion actuators, such that the propulsion capability of the motor vehicle as a whole remains largely intact, e.g., at least 50% of a torque capability of the powertrain system absent execution of the method during a ULM event. The first control action may alternatively include performing a torque vectoring operation in which the electronic controller modifies a relative torque contribution from at least one of the multiple propulsion actuators without necessarily shutting off any of the propulsion actuators.

The method may additionally include executing a second control action during the non-linear operating region when the first control action does not result in the motor vehicle returning to within the calibrated lateral dynamics limits within a predetermined response duration. The second control action may include fully disabling the propulsion capability of the motor vehicle in a manner akin to the control actions taken by the controller during the ULM event when in the linear operating region.

Also disclosed herein is a powertrain system for a motor vehicle. In an aspect of the disclosure, the powertrain system includes multiple propulsion actuators arranged on one or more drive axles, with each propulsion actuator being configured to deliver a corresponding output torque to a particular drive axle. An electronic controller in communication with the multiple propulsion actuators is configured to mitigate a ULM event of the motor vehicle via execution of instructions, with the execution of the instructions causing the electronic controller to perform the above-summarized method.

Instructions embodying the method may be recorded on a non-tangible computer readable storage medium in some implementations, such that execution of the instructions by a processor of an electronic controller causes the electronic controller to perform the present method. For instance, execution of the instructions may cause the electronic controller to identify a present dynamic operating region of the motor vehicle at an onset of the above-described ULM event, with the present dynamic operating region being either the linear operating region or the non-linear operating region.

Execution of the instructions likewise causes the electronic controller to determine whether the lateral motion of the motor vehicle exceeds calibrated lateral dynamic limits for the present dynamic operating region. Moreover, execution of the instructions causes the electronic controller to execute a powertrain control action to mitigate the ULM event, including substantially or fully disabling a propulsion capability of the motor vehicle when the ULM event occurs in the linear operating region. In the non-linear operating region, the controller may execute a progressive control response, i.e., by first attempting for a time to bring the motor vehicle back within its defined lateral dynamic limits before fully disabling the propulsion capability of the motor vehicle. In either event, the powertrain control action changes a dynamic output state of at least one of the multiple propulsion actuators, i.e., a torque and/or speed thereof.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is a schematic illustration of a representative vehicle powertrain system having multiple propulsion actuators and an electronic controller configured to monitor for and mitigate unintended lateral motion of the motor vehicle in accordance with the present disclosure.

FIG. 2 is a schematic illustration of a representative control strategy for use with the vehicle powertrain system shown in FIG. 1.

FIG. 3 is a flow chart describing an embodiment of the present method.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

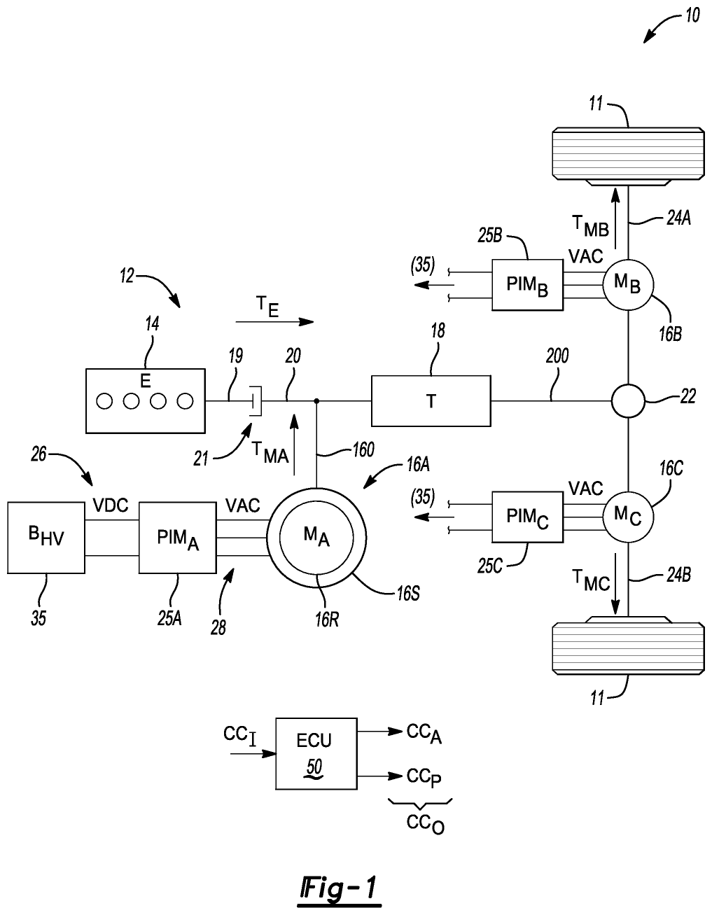

Referring to the drawings, wherein like reference numbers refer to like features throughout the several views, and beginning with FIG. 1, a motor vehicle 10 includes a powertrain system 12 having multiple propulsion actuators as set forth below. In the depicted representative embodiment, the motor vehicle 10 includes one or more driven/powered road wheels 11 in rolling contact with a road surface (not shown). The actual number of road wheels 11 used on a given construction of the motor vehicle 10 may vary, with as few as one road wheel 11 being possible in the context of, e.g., a motorcycle, scooter, trike, or e-bike, and with more than the illustrated number of road wheels 11 being possible in other configurations, such as but not limited to four-wheel drive or all-wheel drive vehicles, trucks, etc. The simplified embodiment of FIG. 1 is therefore intended to illustrate just one possible use of the powertrain system 12. Likewise, while the present teachings lend themselves to use with road wheels 11 having rubber tires of the type used for traction on paved and unpaved road surfaces, those skilled in the art will appreciate that the present teachings may be extended to other types of mobile platforms having multiple propulsion sources regardless of the existence or absence of rubber tires on the road wheels 11.

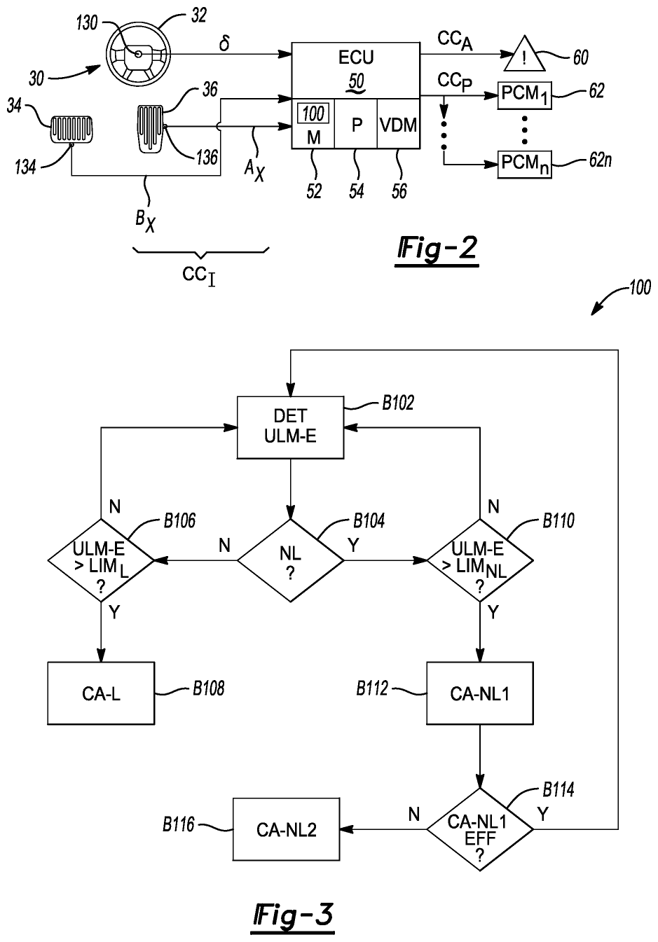

As described in detail herein with reference to FIGS. 2 and 3, the powertrain system 12 includes an electronic control unit (ECU) 50, which is hereinafter referred to as a controller 50 for simplicity. The controller 50 as contemplated herein automatically detects and mitigates unintended lateral motion of the motor vehicle 10, and does so in different manners depending on whether the motor vehicle 10 is currently operating in a linear or a non-linear operating region. For road vehicles in particular, such as the representative motor vehicle 10 of FIG. 1, those skilled in the art will appreciate that vehicle stability limits are largely dictated by tire dynamics, in particular the lateral and longitudinal tire forces generated under different operating conditions, as well as tire slip ratio and tire slip angle.

As appreciated in the art, lateral tire forces, also referred to as cornering or side forces, are generated by tire slip and enable a vehicle such as the motor vehicle 10 to turn. The lateral tire forces react against the centrifugal forces imparted by a cornering maneuver. The lateral and longitudinal forces on a tire combine as a force vector oriented at the slip angle relative to the longitudinal axis of the tire. In other words, the slip angle as used in the art and herein is the angle between a direction in which the tire is pointed and the direction in which the same tire is actually traveling.

Lateral tire forces tend to peak at a given slip angle. Initially, the amount of lateral tire force a given tire can generate will increase linearly with smaller slip angles. However, at some point corresponding to a peak slip angle, an increase in slip angle will not translate into additional lateral tire forces. Instead, the tire will begin to lose its grip with the road surface, followed by a decrease in lateral tire forces. The tire's dynamic response is thus considered to be linear until the corresponding peak is reached. The motor vehicle 10 operates within the linear operating region under normal/every day driving conditions, especially when cruising or during other steady state or lower speed maneuvers. Within the scope of the disclosure, therefore, the presence of a ULM event is of concern, and far more likely to be caused by a malfunctioning propulsion actuator than by anything else.

Above such a peak, however, the dynamic response becomes non-linear. The tires are said to become “saturated” in the non-linear operating region, i.e., unable to generate additional cornering forces in spite of increased steering requests. Behavior indicative of tire saturation includes sliding or drifting of the motor vehicle 10. During aggressive handling maneuvers of the motor vehicle 10 in the non-linear operating region, the expected control response begins to depart, sometimes drastically, from the driver's expected response. Under some situations, however, such as when off-road driving with aggressive steering on sand dunes or other loose terrain, a ULM event may be tolerated for a time by the operator relative to the same ULM event occurring, e.g., while cruising on pavement in the linear operating region.

To that end, as part of its ongoing monitoring and mitigation efforts the electronic controller 50 of FIG. 1 receives a set of electronic input signals (arrow CC_{I}), with exemplary input signals (arrow CC_{I}) being described below with particular reference to FIG. 2. The controller 50 responds to the input signals (arrow CO during performance of a method 100, via a set of output signals (arrow CC_{O}) inclusive of an alert signal (arrow CC_{A}) and propulsion system control signal (arrow CC_{P}), with an exemplary embodiment of the method 100 shown in FIG. 3. The method 100 may be programmed as computer-readable instructions in the form of an algorithm, with such an algorithm being executable by the controller 50 during ongoing operation of the motor vehicle 10, i.e., in real-time when the motor vehicle 10 operates in a drive mode. In this manner, the controller 50 is able to mitigate the ULM event in one manner when the ULM event occurs during operation in the linear operating region, as described above, and in another manner when the same event occurs in the non-linear operating region.

Within the scope of the present disclosure, the powertrain system 12 of FIG. 1 includes multiple propulsion actuators. The particular locations and constructions of such propulsion actuators may vary with the particular configuration of the motor vehicle 10, and therefore the exemplary configuration shown in FIG. 1 is just one possible implementation. For example, the powertrain system 12 may include an internal combustion engine (E) having an output member 19. The output member 19 may be connectable to an input member 20 of a planetary transmission (T) 18 via an input clutch 21, e.g., a friction plate clutch or a hydrokinetic torque converter assembly. Engine torque (arrow T_{E}) generated by the engine 14 is thus ultimately transferred to the transmission 18 in hybrid embodiments in which the engine 14 is included in the powertrain system 12.

The multiple propulsion actuators of the motor vehicle 10 may also include at least one electric traction motor (M_{A}) 16A. In the illustrated configuration, the traction motor 16A includes a stator 16S and a magnetic rotor 16R. The rotor 16R is disposed radially within the stator 16S and separated therefrom by a small radial airgap (not shown) in the depicted radial flux-type configuration of the traction motor 16A. The stator 16S may be surrounded by the rotor 16R in other configurations, or the electric traction motor 16A may be an axial flux-type machine. Likewise, the particular construction of the rotor 16R may vary based on the configuration of the electric traction motor 16A, with permanent magnet or induction rotors being possible embodiments.

In the exemplary embodiment of FIG. 1, the traction motor 16A is a polyphase/alternating current (AC) traction motor used for generating a motor output torque (arrow T_{MA}). The motor output torque (arrow T_{MA}) is ultimately directed to a coupled load via a rotary output member 160, with the rotary output member 160 being operatively connected to the rotor 16R. Aboard the motor vehicle 10, the coupled load may include one or more of the road wheel(s) 11, and/or one or more drive axles 24A and/or 24B connected thereto. The rotary output member 160 may be variously embodied as a rotatable gear set, a shaft, or another suitable mechanical coupling mechanism. The road wheels 11 in the illustrated use case may be configured as front and/or rear road wheels 11 in different embodiments. Where a single traction motor 16A is used, a differential 22 may be connected to an output shaft 200 of the transmission 18 and used to direct or vector torque as needed to the road wheels 11 disposed on the drive axles 24A and 24B.

Still referring to FIG. 1, the electric traction motor 16A may operate as the sole electric propulsion source aboard the motor vehicle 10. Alternatively, the drive axles 24A and 24B may be individually powered by a corresponding traction motor (MB and Mc) 16B and 16C, possibly smaller or of a lower voltage capability than the traction motor 16A. In such a configuration, motor output torque (arrow T_{MB} or T_{MC}) may be generated and delivered to a corresponding drive axle 24A and 24B, respectively. Although omitted for illustrative clarity, individual wheel motors may be operatively connected to or integrated with the road wheels 11 in other embodiments to enable wheel-based propulsion, e.g., in lieu of the illustrated axle-based propulsion. Thus, the various propulsion actuators of FIG. 1, i.e., the engine 14 and at least one of the electric traction motors 16A, 16B, and 16C, may be used together, alone, or in different locations of the powertrain system 12 within the scope of the disclosure, or at least two of the electric traction motors 16A, 16B, and/or 16C may be used without the engine 14, provided the motor vehicle 10 includes at least two propulsion actuators in its construction.

For a polyphase/alternating current (AC) embodiment of the electric traction motor 16A, the powertrain system 12 includes a power inverter module (PIMA) 25A connected to the traction motor 16A via an AC voltage bus 28. The AC voltage bus provides an AC voltage (VAC) to the stator 16S. Power is supplied to a direct current (DC) side of the same PIM 25A by a DC voltage bus 26. The DC voltage bus 26 carries a DC voltage (VDC), and thus is connected to an onboard voltage supply 35, in this instance an exemplary rechargeable lithium-ion high-voltage battery pack (B_{HV}). As the voltage capability of the voltage supply 35 is typically much higher than auxiliary 12-15V auxiliary voltage levels, e.g., 60V-300V or more, the powertrain system 12 may also be equipped with a DC-to-DC converter, which in turn is connected to a 12-15V auxiliary battery, typically a lead-acid battery. As the DC-DC converter and the auxiliary battery are well understood in the art, these components are omitted from FIG. 1 for illustrative simplicity. For electric axle-driven or wheel-driven implementations, the traction motors 16B and 16C may be connected to the voltage supply 35 by similarly configured power inverter modules (PIM_{B} and PIM_{C}) 25B and 25C.

Referring to FIG. 2, the controller 50 of FIG. 1 functions as an electronic control unit (ECU) aboard the motor vehicle 10 when performing the various logical processes and control actions of the present method 100. To that end, the controller 50 may be configured as a hybrid control module or another suitable powertrain controller responsive for coordinating the various propulsion actuators for use in performing a given drive mode. Control decisions within the scope of control authority of the controller 50 include, at the highest level, determining and commanding an ON/OFF state of each respective one of the propulsion actuators. For propulsion sources in the ON state, such as a running engine 14 or an electrically energized traction motor 16A, 16B, or 16C, the controller 50 also commands generation of an appropriate level of drive torque, i.e., the engine output torque (arrow T_{E}) or the respective motor output torques (arrows T_{MA}, T_{MB}, or T_{MC}) of FIG. 1.

The distributed locations of the propulsion actuators within the illustrated powertrain system 12 of FIG. 1 results in different points of application for the various drive torques noted above, which in turn provides the controller 50 with a torque vectoring capability. For instance, the controller 50 may be able to independently power the drive axles 24A and 24B, whether through the traction motors 16B and 16C of FIG. 1 directly or through operation of the differential 22, e.g., when distributing the engine torque (arrow T_{E}) and/or the motor output torque (arrow T_{MA}) to the road wheels 11.

For the purposes of executing the present method 100, the controller 50 of FIG. 2 is equipped with application-specific amounts of the volatile and non-volatile memory (M) 52 and one or more of processor(s) (P) 54, e.g., microprocessors or central processing units, as well as other associated hardware and software, for instance a digital clock or timer, input/output circuitry, buffer circuitry, Application Specific Integrated Circuits (ASICs), systems-on-a-chip (SoCs), electronic circuits, and other requisite hardware as needed to provide the programmed functionality. In the context of the present disclosure, the controller 50 executes instructions via the processor(s) 54 to cause the controller 50 to perform the method 100.

The controller 50 is in communication with a set of input devices 30, each of the input devices 30 being controllable by an operator of the motor vehicle 10 shown in FIG. 1. The input devices 30 collectively communicate the input signals (arrow CC_{I}) to the controller 50 during the course of execution of the method 100. Signals may be transmitted electronically over hardwired transfer conductors or wirelessly in different approaches. For a typical configuration of the motor vehicle 10, such input devices 30 may include a steering wheel 32, a brake pedal 34, and an accelerator pedal 36. The steering wheel 32 is connected to a steering angle sensor 130, e.g., a rotary encoder, resolver, or other rotary sensor. The steering angle sensor 130, which is operable for measuring and outputting a steering angle signal (6) to the controller 50, is thus embodied as a resolver or an encoder, or another application-suitable sensor capable of determining the present angular position of the steering wheel 32 on its steering axis, as appreciated in the art. Similarly, the brake pedal 34 and the accelerator pedal 36 are equipped with respective pedal sensors 134 and 136 configured to measure and output a corresponding braking or acceleration request signal (arrow Bx or Ax). In different embodiments, the pedal sensors 134 and 136 may be configured as force sensors and/or travel sensors, or as other sensors capable of detecting the driver's desired braking and acceleration levels as applied to the pedals 34 and 36, respectively. Those skilled in the art will appreciate that other sensors could be included in different configurations. For instance, wheel angle sensors may be used for detecting corresponding wheel angles of a rear steer vehicle.

The controller 50 is configured to execute instructions embodying the present method 100, which occurs in response to receipt by the controller 50 of the input signals (arrow CC_{I}) described above. In doing so, the controller 50 accesses a vehicle dynamics model (VDM) 56 stored in memory 52 or otherwise accessible by the processor 54 and determines whether the motor vehicle 10 is presently operating within allowable stability limits. As appreciated in the art, such models are typically used to allow onboard control modules, such as the controller 50 of FIGS. 1 and 2, to accurately predict the dynamic response of the motor vehicle 10 to changing inputs at a given velocity. This response will vary with the steering angle (δ) as measured and reported by steering angle sensor 130 and other inputs based on numerous factors, including the velocity, mass, inertia, and center of mass of the motor vehicle 10, the number and location of propulsion actuators, road conditions, lateral and longitudinal forces, slip angles, and individual speeds of the road wheels 11 and tires mounted thereon, etc.

In using the VDM 56 as part of the present method 100, the controller 50 specifically monitors for unintended lateral motion (ULM) events of the motor vehicle 10 of FIG. 1. Since such events are not intended or commanded by the operator, the controller 50 is programmed to mitigate the ULM event via dynamic state control of one or more of the propulsion actuators, with control actions ranging from reducing the speed or torque contribution thereof to shutting down the propulsion capability of the motor vehicle 10. Thus, the controller 50 is operable for transmitting the propulsion system control signals (arrow CC_{P}) to a corresponding local propulsion control module (PCM₁) 62, . . . , (PCMn) 62n, with “1” and “n” respectively representing a nominal 1^{st} and nth propulsion source for a plurality “n” of such propulsion sources.

As an illustrative example control response scenario, the propulsion system control signals (arrow CC_{P}) could instruct the PCM₁ 62 for the engine 14 of FIG. 1 to turn off the engine 14, resulting in fuel cut off. The PCMₙ 62ₙ for the electric traction motor 16A in turn may command a reduction in motor output torque (arrow T_{MA}), with the PCMₙ 62ₙ for other propulsion actuators being unchanged. At the extreme, the propulsion system control signals (arrow CC_{P}) could cause the PCM_{1, . . . n} to shut down their respective propulsion actuators, thereby temporarily disabling the propulsion capability of the motor vehicle 10 for a time. Propulsion capability could be restored at the next key-on event, or the duration could be extended until maintenance has been performed, e.g., depending on severity.

In addition to transmitting the propulsion system control signals (arrow CC_{P}), or in some instances possibly in lieu thereof, the controller 50 may transmit the alert signal (arrow CC_{A}) to an indicator device 60. In different configurations, the indicator device 60 may be embodied as a warning light arranged on a dashboard, center stack, or heads up display within an interior of the motor vehicle 10, such that the indicator device 60 illuminates in response to the alert signal (arrow CC_{A}), possibly with sounding of an accompanying warning tone properly alerting the driver to a fault condition as set forth below.

Referring now to FIG. 3, the method 100 as described herein may be used aboard the exemplary motor vehicle 10 of FIG. 1, or aboard alternative embodiments thereof having multiple propulsion sources. The use of multiple propulsion sources carries with it an increased likelihood of generating unwanted lateral acceleration and other lateral motion. Such motion may result from transient faults of the various propulsion actuators, for instance a stalled engine 14, or from a sudden torque disturbance caused by an electrical or thermal fault of one of the traction motors 16A, 16B, and/or 16C or associated power electronic hardware. The sudden onset or loss of a corresponding torque contribution from an associated propulsion actuator can result in a noise, vibration, and harshness (NVH). Unexpected NVH events may be concerning to a driver or passengers of the motor vehicle 10 depending on the onset severity, and thus the controller 50 is equipped to monitor for ULM events and mitigate the same via real-time control intervention.

Additionally, the controller 50 shown in FIGS. 1 and 2 acts as a propulsion safety monitor that, as at least part of its designated functionality, oversees the present dynamic states of the various propulsion actuators and determines whether the propulsion actuators are behaving in an expected manner, as informed by vehicle dynamics and the VDM 56 of FIG. 2. Specifically, the controller 50 monitors the dynamic behavior of the motor vehicle 10 in the presence of the changing input signals (arrow CC_{I}). When the motor vehicle 10 operates in the linear operating region, the controller 50 executes a first set of mitigating control actions appropriate to this region. Typically this will entail temporarily disabling the propulsion capability of the motor vehicle 10.

When the driver operates the motor vehicle 10 in the non-linear operating region, however, the controller 50 escalates the mitigating control actions depending on several factors as described below. This progressive approach in the non-linear operating region recognizes the possibility that certain motor vehicles 10, e.g., performance, off road/trail rated, or recreational vehicles, may at times be steered, accelerated, or braked in a manner that is less sensitive to the ULM event from the perspective of the operator. As an illustrative example use case, one may consider a suitably equipped motor vehicle 10 making aggressive turns on a sand dune or on another surface on which the tires temporarily depart from the linear operating range, during which the ULM events contemplated herein may be better tolerated than the same ULM event would be if experienced during the linear operating region.

From a controls perspective, it is often difficult to accurately distinguish between actions of the driver and actions of a malfunctioning propulsion actuator when in the non-linear region, where adherence to the behavior expected by the VDM 56 of FIG. 1 is less certain. Rather than responding in the same manner to a ULM event regardless of whether the motor vehicle 10 is operating in the linear or non-linear dynamic regions, the controller 50 of the present disclosure instead allows for initial mitigating and stabilizing control actions short of fully disabling the propulsion capability of the motor vehicle 10, thereby improving drive quality and driver enjoyment.

Beginning with block B102 (“DET ULM-E”), the controller 50 shown in FIGS. 1 and 2 determines or confirms that the motor vehicle 10 experiences the ULM event. As appreciated in the art, automotive stability control entails real-time monitoring of various rapidly changing system parameters. Foremost among such parameters are the present velocity, yaw rate, wheel slip, and lateral and longitudinal forces of the motor vehicle 10. Based on the collective set of parameters in conjunction with the above-noted VDM 56 of FIG. 2, the controller 50 is able to determine whether the lateral motion was intended by the operator, and thus the controller 50, based on the collective set of input signals (arrow CC_{I}). The method 100 proceeds to block B104 once the controller 50 has confirmed the presence of the ULM event.

As part of the method 100, the controller 50 identifies a present dynamic operating range of the motor vehicle 10 at the onset of the ULM event. As described above, the dynamic operating range is either the linear operating range or the non-linear operating range. For example, at block B104 (“NL?”) the controller 50 may determine from the input signals (arrow CC_{I}) and the VDM 56 whether the motor vehicle 10 is in the non-linear operating region at the onset of the ULM event of block B102.

For this determination, the controller 50 may process the reported steering angle signal (arrow δ of FIG. 2) and possibly other control inputs, such as but not necessarily limited to the illustrated pedal signals (arrows Ax and Bx). Other values such as wheel speeds, yaw rate, and lateral and longitudinal accelerations, whether measured or calculated, may also be used to inform the block B104 decision with greater accuracy. The method 100 proceeds to block B106 when the motor vehicle 10 is not operating in the non-linear operating region, and to block B110 in the alternative when the motor vehicle 10 is operating in the non-linear operating region.

At block B106 (“ULM-E>LIM_{L}?”), the controller 50 determines whether the lateral motion of the motor vehicle 10 exceeds calibrated lateral dynamics limits for the present operating region, in this instance the linear operating region. By way of an example implementation, the memory 52 of the controller 50 could be populated with one or more lookup tables indexed by a velocity of the motor vehicle 10 and, e.g., slip speed, lateral acceleration, lateral yaw rate, and/or other suitable stability parameters, which are typically made available to the controller 50 via, e.g., a controller area network (CAN) bus or other onboard communications network. Propulsion operations of the motor vehicle 10 are permitted to continue when the motor vehicle 10 remains within such lateral dynamic limits. The method 100 proceeds to block B108, however, when the calibrated lateral dynamic limits have been exceeded.

Block B108 (“CA-L”) includes executing a mitigating control action for use in the linear operating region. As the dynamic response of the motor vehicle 10 to a given set of inputs in the linear operating region is typically well defined and thus predictable by the VDM 56 with a high degree of confidence, the controller 50 is able to respond quickly to unintended lateral motion in this region. For instance, as an operator of the motor vehicle 10 cruises at a steady-state speed on a paved highway in the linear operating region, lateral motion of the motor vehicle 10 outside of permissible limits is likely to be indicative of a true fault in one or more of the propulsion actuators.

Accordingly, the controller 50 may respond to such a situation by shutting down the propulsion capability of the motor vehicle 10. Doing so would prevent torque vectoring, which if permitted to occur could exacerbate the lateral motion problem. In FIG. 2, for instance, such an action could be accomplished by transmitting the propulsion system control signals (arrows CC_{P}) to each of the multiple propulsion actuators. Alternatively, a limited “limp home” drive capability may be retained by substantially but not fully disabling propulsion of the motor vehicle 10, e.g., so as to allow just enough propulsion capability to allow the operator to reach a desired destination and seek maintenance. Transient errors may cause the controller 50 to execute block B108, however, with such errors sometimes clearing with the next key-on event and an ensuing drive cycle. Maintenance in this situation may be delayed, or the ULM event could be recorded in memory 52 as a diagnostic code for use in a telematics-based vehicle health report. When the problem repeats over several drive cycles, however, the controller 50 may respond by fully disabling propulsion and alerting the operator to the immediate need for maintenance.

At block B110 (“ULM-E>LIM_{NL}?”), which is analogous to block B106, the controller 50 compares the lateral motion to calibrated lateral motion limits for the non-linear operating region. Such limits may be recorded in memory 52 of the controller 50 and populated with one or more lookup tables indexed by velocity, slip speed, lateral acceleration, lateral yaw rate, and/or other suitable stability parameters, similar to the implementation of block B106 but possibly with different corresponding values. Operation of the motor vehicle 10 is permitted to continue in the non-linear operating region if the motor vehicle 10 remains within such lateral motion limits. The method 100 proceeds in the alternative to block B112 when the calibrated lateral motion limits for the non-linear operating region have been exceeded.

Block B112 (“CA-NL1”) is arrived at as a first level of mitigating control response when the lateral motion limits for the non-linear operating region are exceeded, as determined at block B110. In response to such a condition, the controller 50 of FIGS. 1 and 2 may execute a first control action suitable for use in the non-linear operating region. As noted above, execution of method 100 allows the controller 50, when the motor vehicle 10 is in the non-linear operating region, to take a more calculated or progressive approach to mitigating intervention. Unlike the reliable and repeatable physics models used to implement the VDM 56 of FIG. 1 and monitor for lateral motion when in the linear operating range, it is often far more difficult to do so when in the non-linear operating range, i.e., where the dynamic response of the motor vehicle 10 is less likely to follow the predictions made by the constituent equations of the VDM 56.

Moreover, steering and other requests made by the operator may indicate a desire of the operator to temporarily deviate from the limits of the linear operating region response described above at block B108. The operator may, for instance, be more tolerant of the ULM event in the non-linear region. The controller 50 may therefore execute a less invasive control response at block B112 to allow the driver to continue to operate the motor vehicle 10, at least for a time. When off roading and when performing other aggressive driving maneuvers, this function allows the operator to continue to drive the motor vehicle 10 as intended, provided the control actions taken at block B112 succeed in bringing the motor vehicle 10 back within its defined dynamic limits.

An exemplary control action that may be performed at block B112 includes shutting down one or more of the propulsion actuators while leaving at least one remaining propulsion actuator unrestricted in its operation. Alternatively, the controller 50 may perform a torque vectoring operation to offload torque from a given propulsion actuator to another available drive axle, such as by reducing the motor output torque (arrow T_{MC}) from electric traction motor 16C of FIG. 1 and commanding the electric traction motor 16B to make up the difference via the motor output torque (arrow T_{MB}).

Other possible implementations include derating one or more of the electric traction motors 16A, 16B, and/or 16C via switching control of the associated PIM 25A, 25B, and/or 25C, such that the affected electric traction motor(s) 16A, 16B, or 16C are unable to output more than a threshold amount of torque. Similar actions could be performed for the engine 14, such as by spark retarding or cylinder deactivation, or by control of the input clutch 21. Other mitigation efforts may be performed in the context of block B112, including forcing a specific Torque vectoring ratio among two or more of the traction motors 16A, 16B, and/or 16C to remove errant torque vectoring commands from the controls. The method 100 proceeds to block B114 once the control action of block B112 has been attempted.

At block B114 (“CA-NL1 EFF?”), the controller 50 processes available data indicative of the present vehicle dynamic state and determines whether the intervening control actions taken at block B112 were effective in bringing the motor vehicle 10 back within the defined dynamic limits of the non-linear operating region. The evaluation performed at block B114 may rely on reported lateral yaw and acceleration, wheel slip, velocity of the motor vehicle 10, and other relevant parameters when making this determination. If the initial control actions undertaken at block B112 were effective, the controller 50 responds by returning to block B102 and thereafter continuing with another iteration of the method 100 in the manner described above. The method 100 proceeds in the alternative to block B116 when the initial control actions of block B112 are ineffective in bringing the motor vehicle 10 under control relative to the above-noted non-linear dynamic limits within a predetermined response duration, e.g., 1-2 seconds or another application suitable duration.

Block B116 (“CA-NL2”) is arrived at as a second and more intrusive level of mitigating control response when the motor vehicle 10 continues to violate the lateral motion limits for the non-linear operating region, in spite of the less intrusive mitigating efforts attempted at block B112. In response, the controller 50 may execute a second control action suitable for use in the non-linear operating region.

In some implementations, the controller 50 may perform the actions taken at block B108 in the linear operating region, such as by shutting down or disabling propulsion. Alternatively, block B116 may involve performing a mitigating control action short of full shut down, such as preserving a limp home level of propulsion capability via a designated one of the available propulsion actuators. Concurrently, the controller 50 may instruct the operator in such a limp home mode, via the alert device 60 of FIG. 2, a text message, an e-mail, etc., to turn off the motor vehicle 10 to allow a possible transient fault to clear, thereafter resuming full propulsion capabilities with the next key-on event or drive cycle. The controller 50 may thereafter disable propulsion functions if the problem repeats itself in succession or periodically recurs.

Those skilled in the art will appreciate that the method 100 of FIG. 3 may be programmed onto a tangible, non-transitory computer readable storage medium, i.e., the memory 52 of FIG. 2, and thus made executable by the processor 54 or another suitable processing device hosted by the motor vehicle 10 of FIG. 1. Exemplary tangible storage media that may be embodied by the memory 52 of FIG. 2 include, e.g., a solid-state drive (SSD), a hard-disk drive (HDD), or other optical and/or magnetic memory device(s). The method 100 or parts thereof may be alternatively executed by one or more networked devices other than the controller 50, encoded in firmware or in dedicated hardware such as in an application specific integrated circuit (ASIC), a programmable logic device (PLD), a field programmable logic device (FPLD), discrete logic, etc. Further, although a specific algorithm is described with reference to FIG. 3, other methods for implementing the example machine-readable instructions may be used in the alternative in other embodiments within the scope of the present disclosure.

To that end, the memory 52 may embody a non-tangible computer readable storage medium on which instructions are recorded for mitigating the ULM event described above. In such an embodiment, the execution of the instructions by the processor 54 of the electronic controller 50 causes the electronic controller 50 to identify a present dynamic operating region of the motor vehicle 10 at an onset of the ULM event, with the present dynamic operating region being the linear operating region or the non-linear operating region within the calibrated VDM 56. The lateral motion of the motor vehicle 10 occurring during the ULM event as contemplated herein include lateral acceleration and/or lateral yaw rate of the motor vehicle 10.

In an embodiment, execution of the instructions causes the controller 50 to determine whether the lateral motion of the motor vehicle 10 exceeds calibrated lateral dynamic limits for the present dynamic operating region, and to execute a powertrain control action to mitigate the ULM event. For instance, instruction execution could cause the controller 50 to fully disable the propulsion capability of the motor vehicle 10 when the ULM event occurs in the linear operating region, and to initially execute a different control response that preserves at least some of the propulsion capability when the ULM event occurs in the non-linear operating region. The powertrain control action in either case includes changing a dynamic state of at least one of the multiple propulsion actuators.

As set forth above, the control actions triggered by execution of the instructions embodying method 100 may include, as a first control action, reducing the propulsion capability of at least one but fewer than all of the multiple propulsion actuators of the motor vehicle 10 for a calibrated duration. In response to the first control action not resulting in the motor vehicle 10 returning to within the calibrated lateral dynamic limits of the non-linear operating region within a predetermined response duration, the controller 50 may be caused to execute a second control action, such as fully disabling the propulsion capability of the multiple propulsion actuators. In this manner an operator of the motor vehicle 10 of FIG. 1 is able to enjoy extended use of the motor vehicle 10 in the non-limiting operating region when propulsion capability might otherwise be unavailable.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for mitigating an unintended lateral motion (ULM) event of a motor vehicle having a powertrain system, the powertrain system including multiple propulsion actuators, the method comprising:
identifying, via an electronic controller of the motor vehicle, a present dynamic operating region of the motor vehicle at an onset of the ULM event, wherein lateral motion of the motor vehicle occurring during the ULM event includes a lateral acceleration and/or a lateral yaw rate of the motor vehicle;
determining, via the electronic controller, whether the lateral motion exceeds calibrated lateral dynamic limits for the present dynamic operating region; and
executing a powertrain control action, via the electronic controller, to thereby mitigate the ULM event in a first manner that substantially or fully disables a propulsion capability of the motor vehicle when the present dynamic operating region is a linear operating region, and in a second manner that temporarily permits continued operation of the motor vehicle when the present dynamic operating region is a non-linear operating region, wherein the powertrain control action includes changing a dynamic output state of at least one of the multiple propulsion actuators.

2. The method of claim 1, further comprising:
detecting the onset of the ULM event by measuring the lateral acceleration and/or the lateral yaw rate of the motor vehicle.

3. The method of claim 1, wherein determining, via the electronic controller, whether the lateral motion exceeds the calibrated lateral dynamic limits for the present dynamic operating region includes comparing the lateral motion to one or more lookup tables in memory of the electronic controller.

4. The method of claim 3, wherein comparing the lateral motion to the one or more lookup tables includes comparing a lateral tire force and a tire slip angle of the motor vehicle to respective calibrated thresholds stored in the one or more lookup tables.

5. The method of claim 1, wherein the motor vehicle includes a steering wheel and a steering angle sensor configured to measure a steering angle thereof, the method further comprising:
measuring the steering angle via the steering angle sensor; and
transmitting a steering angle signal to the electronic controller that is indicative of the steering angle, wherein identifying the present dynamic operating region of the motor vehicle includes processing the steering angle signal via a processor of the electronic controller.

6. The method of claim 1, wherein executing the powertrain control action includes fully disabling the propulsion capability of the motor vehicle when the ULM event occurs in the linear operating region.

7. The method of claim 1, wherein executing the powertrain control action includes executing a first control action when the ULM event occurs in the non-linear operating region, the first control action including reducing a propulsion capability of at least one but fewer than all of the multiple propulsion actuators.

8. The method of claim 7, wherein the first control action includes commanding a torque vectoring operation which modifies a relative torque contribution from at least one of the multiple propulsion actuators.

9. The method of claim 7, further comprising:
executing a second control action when the first control action does not result in the motor vehicle returning to within the calibrated lateral dynamic limits within a predetermined response duration, the second control action including fully disabling the propulsion capability of the motor vehicle.

10. A powertrain system for a motor vehicle, comprising:
multiple propulsion actuators arranged on one or more drive axles and configured to deliver a corresponding output torque thereto; and
an electronic controller in communication with the multiple propulsion actuators, wherein the electronic controller is configured to mitigate an unintended lateral motion (ULM) event of the motor vehicle via execution of instructions, the execution of the instructions causing the electronic controller to:
identify a present dynamic operating region of the motor vehicle at an onset of the ULM event, wherein the present dynamic operating region is a linear operating region or a non-linear operating region, and wherein lateral motion of the motor vehicle occurring during the ULM event includes a lateral acceleration and/or a lateral yaw rate of the motor vehicle;
determine whether the lateral motion exceeds calibrated lateral dynamic limits for the present dynamic operating region; and
execute a powertrain control action to mitigate the ULM event in a first manner when the ULM event occurs in the linear operating region, the first manner substantially or fully disabling a propulsion capability of the motor vehicle, and in a second manner that temporarily permits continued operation of the motor vehicle when the ULM event occurs in the non-linear operating region, wherein the powertrain control action includes changing a dynamic output state of at least one of the multiple propulsion actuators.

11. The powertrain system of claim 10, wherein the electronic controller is configured to detect the onset of the ULM event by receiving the lateral acceleration and/or the lateral yaw rate from an accelerometer and/or a yaw rate sensor, respectively.

12. The powertrain system of claim 10, wherein the electronic controller is configured to determine whether the lateral motion exceeds the calibrated lateral dynamic limits for the present dynamic operating region by comparing the lateral motion to at least one lookup table stored in memory of the electronic controller.

13. The powertrain system of claim 12, wherein the at least one lookup table is indexed by a lateral tire force and a tire slip angle of a set of road wheels of the motor vehicle.

14. The powertrain system of claim 10, further comprising a steering wheel and a steering angle sensor configured to measure a steering angle thereof, wherein the execution of the instructions causes the electronic controller to:
receive a steering angle signal from the steering angle sensor that is indicative of the steering angle; and
determine whether the motor vehicle is operating in the non-linear operating region or the linear operating region by processing the steering angle signal via a processor of the electronic controller.

15. The powertrain system of claim 10, the powertrain control action in the first manner includes fully disabling the propulsion capability of the motor vehicle.

16. The powertrain system of claim 10, wherein the powertrain control action in the second manner includes, as a first control action, reducing a respective propulsion capability of at least one but fewer than all of the multiple propulsion actuators.

17. The powertrain system of claim 16, wherein the first control action includes commanding a torque vectoring operation which modifies a relative torque contribution from at least one of the multiple propulsion actuators.

18. The powertrain system of claim 16, wherein the electronic controller is configured to execute a second control action when the first control action does not result in the motor vehicle returning to within the calibrated lateral dynamic limits within a predetermined response duration, the second control action including fully disabling a propulsion capability of the multiple propulsion actuators.

19. A non-tangible computer readable storage medium on which instructions are recorded for mitigating an unintended lateral motion (ULM) event of a motor vehicle having a powertrain system, the powertrain system including multiple propulsion actuators, wherein execution of the instructions by a processor of an electronic controller causes the electronic controller to:
identify a present dynamic operating region of the motor vehicle at an onset of the ULM event, wherein the present dynamic operating region is a linear operating region or a non-linear operating region, and wherein lateral motion of the motor vehicle occurring during the ULM event includes lateral acceleration and/or a lateral yaw rate of the motor vehicle;
determine whether the lateral motion exceeds calibrated lateral dynamic limits for the present dynamic operating region; and
execute a powertrain control action to mitigate the ULM event, including fully disabling a propulsion capability of the motor vehicle when the ULM event occurs in the linear operating region, and executing a different control response when the ULM event occurs in the non-linear operating region to at least temporarily permit continued operation of the motor vehicle in the non-linear operating range, wherein the powertrain control action includes changing a dynamic output state of at least one of the multiple propulsion actuators.

20. The non-tangible computer readable storage medium of claim 19, wherein execution of the instructions by the processor of the electronic controller causes the electronic controller to perform the graduated control response by:
reducing the propulsion capability of at least one but fewer than all of the multiple propulsion actuators for a predetermined response duration, as a first progressive control action; and
in response to the first progressive control action not resulting in the motor vehicle returning to within the calibrated lateral dynamic limits within the predetermined response duration, fully disabling the propulsion capability of the motor vehicle as a second control action.
